(19) United States
(12) Patent Application Publication
(10) Pub. No.: US 2013/0043270 A1
(43) Pub. Date: Feb. 21, 2013

(54) BEVERAGE VENDING MACHINE CUP FEED UNIT

(71) Applicant: Sergio Pesenti Barili, Stezzano (IT)

(72) Inventor: Sergio Pesenti Barili, Stezzano (IT)

(73) Assignee: N&W GLOBAL VENDING S.P.A., Valbrembo (IT)

(21) Appl. No.: 13/511,591

(22) PCT Filed: Nov. 25, 2010
(86) PCT No.: PCT/IB10/03009

§ 371 Date: Sep. 27, 2012

(30) Foreign Application Priority Data
Nov. 25, 2009 (IT) TO2009A000913

(51) Int. Cl. G07F 13/10

(52) U.S. Cl. 221/194

(57) ABSTRACT

A cup feed unit for supplying cups in a beverage vending machine, wherein the cups are fed through an annular body, which has a substantially vertical axis, internally defines a through passage of diameter D, and has a number of locators, which are fitted to the annular body, are equally spaced about the axis, and are movable between a normal rest position, in which the locators limit the through passage to define a smaller passage of diameter D1<D, and a withdrawn position, in which the locators are positioned outside the through passage.

### TECHNICAL FIELD

The present invention relates to a beverage vending machine cup feed unit.

### BACKGROUND ART

A beverage vending machine cup feed unit normally serves to receive a cup from a cup store inside the machine, and move the cup into a fill position, in which it is filled with the beverage ingredients.

Because the cup has to be positioned accurately in the feed unit, to ensure it is centred with respect to the dispensing members when it is filled, the feed unit normally comprises a locating system for “correcting” the position of the empty cup, if necessary.

In multiple-beverage vending machines, it would be desirable to use cups of different types and sizes for different beverages.

As yet, this has not been possible, due to currently used feed unit locating systems only being reliable in locating cups of only slightly different sizes.

### DISCLOSURE OF INVENTION

It is an object of the present invention to provide a cup feed unit that is cheap and easy to produce, and designed to eliminate the above drawback.

According to the present invention, there is provided a cup feed unit as claimed in claim 1 and preferably in any one of the following claims depending directly or indirectly on claim 1.

### BRIEF DESCRIPTION OF THE DRAWINGS

A non-limiting embodiment of the present invention will be described by way of example with reference to the accompanying drawings, in which:

FIG. 1 shows a view in perspective, with parts removed for clarity, of a detail of a preferred embodiment of the cup feed unit according to the present invention;

FIGS. 2 and 3 show larger-scale sections of a detail in FIG. 1 in respective operating configurations;

FIGS. 4A-4D and 5A-5D show respective operating sequences of the FIG. 1 feed unit.

### BEST MODE FOR CARRYING OUT THE INVENTION

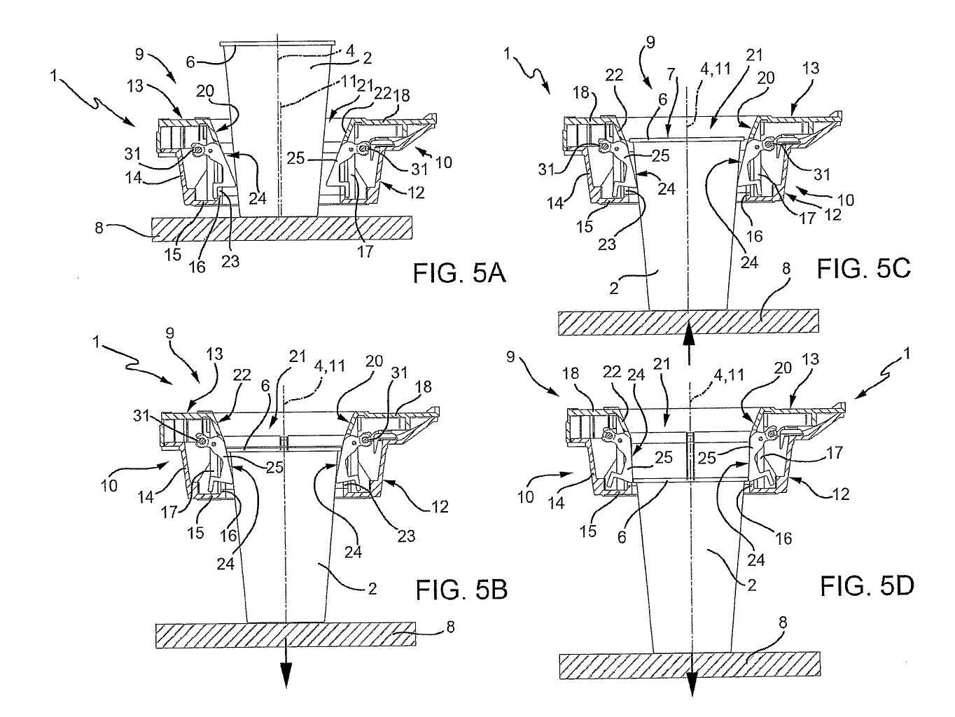

Number 1 in FIG. 4A indicates as a whole a cup feed unit for supplying cups 2 in a multiple-beverage vending machine 3.

Cup 2 is of the type normally used in beverage vending machines, and is defined by a cup-shaped body of plastic or paper material, having a longitudinal axis 4 and a truncated-cone-shaped lateral wall 5, which is closed at the narrow end by a flat bottom wall, and at the wide end has an annular flange 6 about the whole of the mouth 7 of cup 2.

In machine 3, unit 1 is normally located next to a pickup compartment (not shown) accessible from the outside, and, during a normal operating cycle of machine 3, is designed to receive a cup 2 from a store (not shown) inside machine 3, and set cup 2, as explained below, into a fill position, and then into a pickup position for removal by the user from the outside. Because the range of beverages produced makes it necessary to use cups 2 of different sizes, the store (not shown) comprises, in known manner, a number of selectively activated stores, each housing a number of cups 2 of a respective size, normally arranged in at least one stack. Each store (not shown) comprises, in known manner, a respective known release device which, when activated, releases a cup 2 from the bottom of the stack; and a feed device (not shown), normally a fixed chute, which receives a cup 2 from the release device, and feeds cup 2, with its concavity facing upwards, to unit 1.

As shown in FIGS. 4A-4D, unit 1 comprises a substantially horizontal stand 8 which is located inside the pickup compartment (not shown), defines a support for cup 2, and is fitted to the casing (not shown) of machine 3 to translate vertically between a top or receiving position (FIG. 4A), in which stand 8 receives an empty cup 2 fed downwards by the feed device (not shown); a first intermediate or locating position (FIG. 4B) described in detail below; a second intermediate or fill position (FIG. 4C), in which stand 8 supports cup 2 beneath and a given distance from one or more known nozzles (not shown) for dispensing the beverage or beverage ingredients; and a bottom or pickup position (not shown), in which the filled cup 2 is withdrawn by the user from the outside.

Directly over stand 8, unit 1 comprises a locating device 9 for correcting, if necessary, the transverse position of cup 2 before it is filled.

Locating device 9 comprises a funnel-shaped annular body 10 connected rigidly to the casing (not shown) of machine 3, and having a vertical axis 11 which defines a predetermined centred position of cup 2 on stand 8, i.e. the position cup 2 must assume on stand 8 to centre mouth 7 with the nozzles when filling the cup, and so prevent spillage of beverage or ingredients. Cup 2 is in the centred position when its axis 4 coincides with axis 11 of body 10.

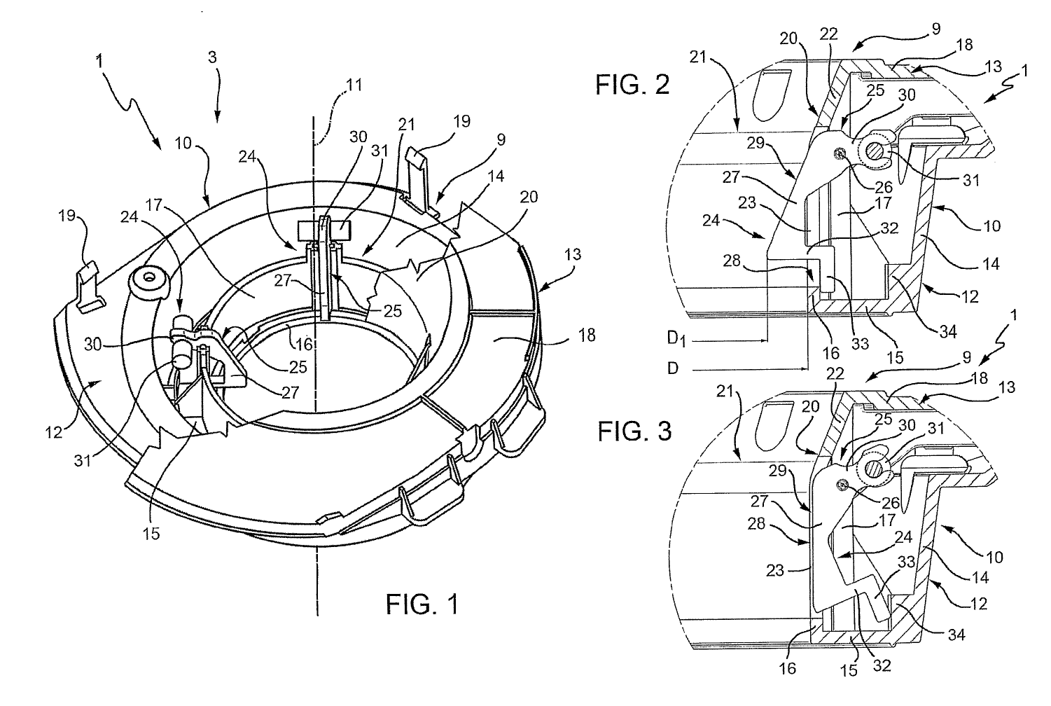

As shown in FIGS. 1 and 4, body 10 comprises a bottom portion 12 and a top portion 13 (shown partly in FIG. 1) assembled to each other.

More specifically, bottom portion 12 has an open-topped U-shaped cross section, and comprises a truncated-cone-shaped outer wall 14 tapering towards and coaxial with axis 11; and an annular bottom wall 15 perpendicular to axis 11 and fitted rigidly, along its free inner edge, with an annular rib 16 coaxial with axis 11. Close to rib 16, bottom wall 15 is also fitted with a tubular appendix 17 which faces outer wall 14, is coaxial with axis 11, and is higher than rib 16 and lower than outer wall 14.

Top portion 13 closes the top of bottom portion 12, and comprises an annular top wall 18 substantially parallel to bottom wall 15 and connectable to bottom portion 12 by fasteners 19 on bottom portion 12.

Top portion 13 also comprises a tubular wall 20 which is integral with an inner peripheral edge of top wall 18, extends, coaxially with axis 11, down to rib 16, and defines a through channel 21.

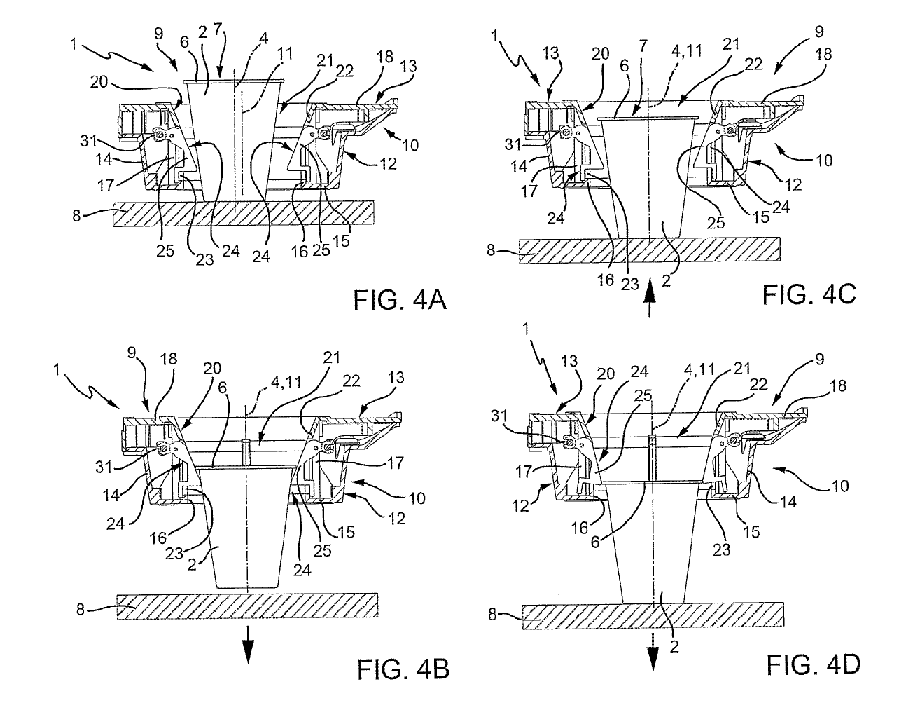

As shown more clearly in FIGS. 2 and 3, tubular wall 20 comprises a truncated-cone-shaped inlet portion 22 tapering downwards towards axis 11; and a cylindrical portion 23 which is connected to inlet portion 22, defines a bottom portion of channel 21, and has an inside diameter equal to the inside diameter of rib 16—to which inlet portion 22 is contiguous—and larger than the diameter of flange 6 of the cups 2, of whatever size, used in machine 3.

As shown in FIGS. 1, 2 and 4, locating device 9 comprises four locators 24, which are passive contrast members fitted to bottom portion 12, and which, following a movement of stand 8, moves into contact with an empty cup 2 on stand 8, to move cup 2 transversely, if necessary, into the centred position. Locators 24 are equally spaced about axis 11, and each comprise a rocking arm 25 hinged to tubular appendix 17 by a respective pin 26 crosswise to axis 11, and comprising a lever arm 27 which oscillates in a radial plane through axis 11, and moves, via a number of intermediate positions, between a normal rest position (FIG. 2), in which lever arm 27 extends partly inside channel 21, and a withdrawn position (FIG. 3), in which lever arm 27 is withdrawn completely from channel 21 and defines, with the other lever arms 27, a passage equal in diameter to diameter D.

More specifically, as shown in FIGS. 4 and 5, lever arms 27 in the rest position define, inside channel 21, a passage with a diameter D1 smaller than the diameter of flange 6 of cups 2, of whatever size, used in machine 3.

Each lever arm 27 extends through a respective slot in tubular wall 20, and is bounded, on the side facing axis 11, by an edge 29 which, when lever arm 27 is in the rest position (FIG. 2), projects towards axis 11 from tubular wall 20, and slopes with respect to axis 11 by the same angle as inlet portion 22, so as to form, with edges 29 of the other rocker arms 25, a truncated-cone-shaped portion tapering downwards towards axis 11 and substantially contiguous to inlet portion 22.

Rocker arm 25 also comprises an arm 30, which is shorter than lever arm 27, extends substantially crosswise to lever arm 27, and is fitted on its free end with a counterweight 31 for normally maintaining rocker arm 25 balanced stably in the rest position.

In an embodiment not shown, arm 30 and counterweight 31 are replaced by a spring fitted to pin 26 to normally maintain rocker arm 25 balanced stably in the rest position.

At the free end of edge 29, lever arm 27 has a right-angle appendix comprising a portion 32 connected to edge 29 and extending from edge 29 towards outer wall 14; and a portion 33 extending towards bottom wall 15 from a free end of portion 32, and which cooperates with stops to accurately define the rest position and withdrawn position of rocker arm 25. Accordingly, the end of portion 33 is movable inside the gap between rib and outer wall 14, so as to contact rib 16 when counterweight 31 pushes rocker arm 25 into the rest position (FIG. 2), and to contact a projection 34 on outer wall 14 when rocker arm 25 is pushed by a cup 2 into the withdrawn position (FIG. 3).

In a variation not shown, rocker arms 25 may number other than the four in the example show. For example, in a simplified embodiment, three rocker arms 25, equally spaced about axis 11, may be sufficient.

Operation of unit 1 will now be described as of the operating sequence in FIGS. 4A-4D.

In FIG. 4A, stand 8 is in the raised position, and rocker arms 25 in the rest position.

When a beverage is selected by the user, a cup 2 of a suitable size for the selected beverage is released by the feed device (not shown), and drops through channel 21 onto stand 8.

The FIG. 4A-4D operating sequence refers to a released cup 2 of relatively small size.

Because cup 2 is not guided along the final leg of its fall through channel 21, the position of cup 2 on stand 8 is rarely centred with respect to axis 11, and, in most cases, as in the example shown, axis 4 of cup 2 is out of line with axis 11 of channel 21.

At this point, stand 8 is lowered vertically for a given time, depending on the type of cup 2 used, into the locating position (FIG. 4B); and, as stand 8 is lowered, cup 2 moves down and, as it does, is gradually centred with respect to axis 11 by edges 29 of rocker arms 25 contrasting the lateral wall 5 of cup 2.

Because the cup 2 in the example shown is not heavy enough to push rocker arms 25 crosswise in opposition to counterweights 31, cup 2 continues falling until it eventually fits between rocker arms 25 in the rest position (FIG. 4B), and is centred with axis 4 perfectly aligned with axis 11. To centre cup 2, stand 8, in this case, must therefore be lowered to leave cup 2 suspended between rocker arms 25.

At this point, stand 8 is moved back up into the fill position (FIG. 4C); and, because no crosswise force is exerted on cup 2 during this upward movement, cup 2 remains as it was in the centred position.

Once cup 2 is filled, stand 8 is lowered into the pickup position lower down than the locating position. During which movement, the filled cup 2 is heavy enough to move rocker arms 25 crosswise into the withdrawn position, and so slip out of body 10 (FIG. 4D).

FIGS. 5A-5D refer to a user-selected beverage requiring a bigger cup 2 than in the above example.

In this case, the operating sequence of unit 1 is substantially the same as in FIGS. 4A-4D, except that the up and down movements of stand 8 are adapted to the size of cup 2.

More specifically, in this case, when stand 8 is lowered into the locating position, the empty cup 2 is heavy enough to push rocker arms 25 crosswise and rotate them about respective pins 26 in opposition to respective counterweights 31.

In this case, to prevent the empty cup 2 from slipping out of body 10 as stand 8 is lowered into the locating position, the downward travel of stand 8 is therefore stopped as the centred cup 2, still resting on stand 8, begins moving rocker arms 25 into their respective rest positions.

1. A cup feed unit for supplying cups in a beverage vending machine, the cup feed unit comprising:
an annular body having a substantially vertical axis and defining internally an axial through passage of diameter D;
a number of locators that are fitted to the annular body, are substantially equally spaced about the axis, and are movable between a normal rest position in which the locators limit said axial through passage to define a smaller passage of diameter D1<D and a withdrawn position in which the locators are positioned outside the axial through passage; and
movable supporting means mounted beneath the annular body to support and move along the axis a cup having a maximum diameter between D and D1, and fed downwards, in use, through the annular body.

2. The cup feed unit as claimed in claim 1, wherein the locators are passive members movable by said cup; said normal rest position being a position of stable equilibrium.

3. The cup feed unit as claimed in claim 1, wherein the locators comprise respective lever arms mounted to oscillate, about respective fixed axes, in respective planes radial with respect to the axis.

4. The cup feed unit as claimed in claim 3, wherein each lever arm has a lateral edge facing the axis and which, when the relative locator is in the rest position, slopes with respect to the axis to impart to said smaller passage, together with said lever arms of the other locators, a truncated-cone shape tapering downwards towards the axis.

5. The cup feed unit as claimed in claim 3, further comprising restoring means configured to push each lever arm into the normal rest position.

6. The cup feed unit as claimed in claim 5, wherein the lever arm forms part of a respective rocker arm comprising a further arm; the restoring means being counterweight means carried by the further arm.

7. The cup feed unit as claimed in claim 1, further comprising stop means configured to define the rest position and the withdrawn position of each locator.

8. The cup feed unit as claimed in claim 1, wherein the movable supporting means are mounted to translate along the axis to and from a lowered locating position in which they are located at such a distance from the annular body as to leave the cup in a position of interference with the locators.

9. A beverage vending machine comprising the cup feed unit for supplying cups, as claimed in claim 1.

10. A cup feed unit for supplying cups in a beverage vending machine, the cup feed unit comprising:
an annular body defining a substantially vertical axis and an internal axial through passage having a diameter D;
a plurality of locators that are fitted to the annular body, the plurality of locators are substantially equally spaced about the substantially vertical axis and movable between a normal rest position in which the plurality of locators limit the internal axial through passage to define a smaller passage of diameter D1<D and a withdrawn position in which the plurality of locators are positioned outside the internal axial through passage; and
a movable support structure mounted beneath the annular body to support a cup having a maximum diameter between D and D1 that is fed downwards through the annular body during use, the moveable support structure configured to move the cup along the axis.

11. The cup feed unit as claimed in claim 10, wherein the plurality of locators are passive members movable by the cup.

12. The cup feed unit as claimed in claim 10, wherein the plurality of locators comprise respective lever arms mounted to oscillate, about respective fixed axes, in respective planes radial with respect to the axis.
